(19) United States
(12) Patent Application Publication
(10) Pub. No.: US 2026/0301055 A1
(43) Pub. Date: Oct. 1, 2026

(54) GENERATING STRUCTURED USER INTERFACE ELEMENTS BY APPLYING GENERATIVE MODEL TO UNSTRUCTURED TEXT RECEIVED IN MESSAGING INTERFACE

(71) Applicant: Maplebear Inc., San Francisco, CA (US)

(72) Inventor: Naval Shah, Toronto (CA)

(21) Appl. No.: 19/094,573

(22) Filed: Mar. 28, 2025

(51) Int. Cl. G06Q 30/0601; G06Q 10/0875

(52) U.S. Cl. CPC G06Q 30/0633; G06Q 10/0875; G06Q 30/0641

(57) ABSTRACT

An online system provides a communication interface enabling users to communicate with pickers who are fulfilling orders placed by users. The communication interface allows a user to request modifications to an order (e.g., adding or removing an item or adding a note for the picker about an ordered item). However, messages received from the communication interface are unstructured, so a user's requested modification for an item may be mistaken by a picker to relate to a different item. To prevent such confusion, the system uses an artificial intelligence (AI) agent (e.g., a tuned large language model) to interpret user requests and to generate an action plan comprising structured data for the picker. The action plan is presented as a user interface element in the communication interface to the user for confirmation, and the picker performs the action plan when it is confirmed by the user.

### BACKGROUND

Various online systems offer items for acquisition by users, with a user selecting one or more items through interaction with the online system. For example, a user selects one or more items for inclusion in an order through one or more interfaces generated and presented by the online system. Subsequently, the user receives the selected items included in the order from the online system. For example, the online system allocates an order from a user to a picker who obtains items included in the order from a source and delivers the obtained items to a location included in the order.

Many online systems enable communication between a user and a picker through one or more communication interfaces as the picker fulfills an order from the user. For example, a user receives messages from a picker via a communication interface indicating one or more items are unavailable at a source, requesting identification of a replacement item that is unavailable at a source, or requesting clarification of a quantity or a size of an item to obtain from the source. Similarly, the user transmits messages to the picker via the communication interface to request actions by the picker when fulfilling an order. For example, a user transmits a message to a picker via the communication interface to add one or more items to the order or to modify a quantity of one or more items included in the order.

Such a communication interface often facilitates communication between a picker and a user while the picker fulfills an order by receiving messages comprising unstructured text. While transmitting messages comprising unstructured text simplifies generation of messages by a user or by a picker, the unstructured text often creates ambiguity for the picker in determining an action to perform in response to a message via the communication interface. For example, a message from a user to a picker requests the picker add “milk” to the order the picker is fulfilling, but does not identify a specific item (e.g., a specific size or brand of milk) for the picker to obtain in response to the message. Similarly, a message includes a description of an item in an order or attributes of items in the order rather than identifying the specific item, causing the picker to manually review attributes of items in the order to identify the item in the order referred to by the message. Conventionally, pickers resolve such ambiguity by exchanging further messages with the user. However, this increases an amount of time the picker and the user interact through the communication interface, increasing computing resources used by the client devices of the picker and the user while the picker fulfills an order, while also increasing an amount of time for the picker to fulfill the order.

### SUMMARY

In accordance with one or more aspects of the disclosure, an online system receives orders from various users. An order identifies one or more items as well as a source for obtaining the identified items. Further, the order may include information about fulfilling the order, such as a time interval for the user to receive items from the order and a location to which items from the order are to be provided after being obtained from the identified source. Additional or alternative information may be included in the order in various embodiments.

The online system allocates an order to a picker, who obtains items included in the order and delivers the obtained items to a location identified by the order. While the picker fulfills the order, the online system enables the picker and the user to communicate with each other through a communication interface. Using a user client device, the user creates a text-based message through the communication interface that the user client device transmits to the picker client device. A communication interface on the picker client device presents the message to the picker and allows the picker to create a text-based message that is transmitted to the user client device. Messages generated through the communication interface are unstructured text, simplifying message creation by the user and by the picker to reduce an amount of time for the user and the picker to exchange messages.

Messages from the user to the picker while the picker is fulfilling an order allow the user to identify modifications to the order, allowing the user to adjust how the picker fulfills the order through one or more messages. For example, a message from the user to the picker requests the picker obtain an additional item while fulfilling the order. As another example, a message from the user to the picker requests the picker obtain a different quantity of an item included in the order.

While having the picker and the user compose messages through unstructured text simplifies message composition, using unstructured text increases ambiguity in communication between the picker and the user during order fulfillment. For example, a message from a user includes a generic description of an item or attributes of an item rather than a specific item the picker is capable of obtaining from the source. In an example, a message from the user requests the picker to also obtain “milk” in addition to the items included in the order, but does not identify a specific milk item to obtain. Conventionally, the picker resolves such ambiguity by transmitting additional messages to the user identifying one or more specific items available from the source that have attributes at least partially matching content from the message from the user or by transmitting additional messages that request more specific information from the user. This increases an amount of data exchanged between the picker client device and the user client device, which increases the bandwidth of the network used by the user device and the picker client device. Further, an increased number of messages exchanged between the user client device and the picker client device increases an amount of time the picker client device and the user client device display the communication interface, which increases power consumption by the picker client device and by the user client device. Additionally, exchanging a larger number of messages between the picker and the user while the picker fulfills an order increases a length of time the picker and the user interact with their respective communication interfaces, which increases an amount of time for the piker to fulfill the order.

For example, a message from the user includes a request for the picker to obtain an additional item that was not included in the order that the picker is fulfilling. However, the message may not identify a specific item to obtain, but instead includes a generic description of “milk” as the additional item for the picker to obtain. Conventionally, the picker would provide additional messages, and the user would provide additional messages to the picker to ascertain a specific item to obtain to satisfy the generic item description included in the message.

To reduce interaction with the communication interface for a user to convey more modifications to the order to the picker fulfilling the order, the online system determines a type of request corresponding to the message. Example types of requests include: a request to add an item to the order, a request to modify one or more items included in the order (e.g., increase a quantity of an item to obtain, decrease a quantity of an item to obtain), and a request to add one or more notes for obtaining an item for the picker. However, in other embodiments, different or additional types of requests may be maintained or identified by the online system. Different types of requests correspond to different types of actions for the picker to perform for the order. Maintaining different types of requests allows the online system to maintain a set of actions to perform for an order.

In various embodiments, the online system uses a generative model, such as a large language model (LLM), to determine the type of request for the message. For example, the online system generates a prompt for the generative model that includes the message and an instruction to identify a type of request based on the text included in the message. The generative model is pre-trained through application to a training corpus that includes unstructured text obtained from various sources to learn relationships between different portions of text. Based on the previously learned relationships, the generative model generates output text comprising a type of request from the unstructured text of the message the generative model received as an input.

In various embodiments, the online system tunes the generative model to determine the type of request using supplemental examples comprising unstructured text corresponding to different types of requests. For example, the online system generates an embedding for each supplemental example and maintains an index including supplemental examples associated with corresponding types of requests, in some embodiments. The index provides an intermediate representation of supplemental examples in the form of their embeddings rather than text comprising different supplemental examples in various embodiments. The online system generates an embedding for the message and determines measures of similarity (e.g., cosine similarity, dot product) between the embedding for the message and the embeddings for supplemental examples in the index. For example, the online system identifies embeddings of supplemental examples having at least a threshold measure of similarity to the embedding for the message. As another example, the online system ranks supplemental examples based on measures of similarity between their embeddings and the embedding of the message and selects one or more supplemental examples having at least a threshold position in the ranking. The online system includes the one or more selected supplemental examples, or embeddings for the one or more selected supplemental examples, in the prompt for the generative model along with the message and the instruction to identify the type of request. Based on the embeddings of the one or more selected supplemental examples and the message in the prompt, the generative model determines the type of request corresponding to the message.

The online system determines an action plan for the picker based on the type of request and the unstructured text in the message. The action plan comprises structured data based on the message. In various embodiments, the action plan includes specific fields and values for each of the fields that the online system determines based on the message. For example, the action plan includes a field including the type of request and one or more additional fields, and associated values, based on the type of request. For example, the additional fields include values for an item identifier, for a quantity of an item, text for association with an item, or other data relevant to the picker performing an action described by the action plan when fulfilling the order. Having the action plan comprise structured data allows the online system to provide the picker with standardized information based on the unstructured text from the message, allowing the picker to more easily determine one or more actions to perform based on the message, as well as one or more items relevant to the one or more actions to perform.

In various embodiments, the online system determines the action plan by applying the generative model to a prompt including at least a portion of the message and the type of request. The type of request affects data that the online system obtains from the action plan, so the type of request determines one or more fields included in the action plan. For example, a type of request may be to add an additional item to the order, so the online system selects one or more candidate items for inclusion in the order based on the message. To identify the one or more candidate items, the online system generates a search query based on the message using the generative model. Based on the search query, the online system retrieves a set of candidate items from an item catalog of items accessible from a source included in the order. For example, each candidate item has one or more attributes that at least partially match the search query. The online system selects one or more of the candidate items and includes one or more selected candidate items in the action plan. The online system selects the one or more candidate items based on measures of similarity between item embeddings for different candidate items and a search query embedding for the search query. Additional information, such as a predicted availability of different candidate items at the source identified by the order or prior inclusion of candidate items in orders fulfilled for the user may additionally or alternatively be used by the online system to select one or more candidate items. The generative model may determine other data for the action plan from the message, such as a quantity of a candidate item to obtain based on the message.

As another example, a type of request to modify one or more items included in the order causes the online system to retrieve the order and to identify an item in the order based on the message. The online system applies the generative model to a prompt including the order, or the items in the order, and the message to identify the item in the order corresponding to the message. For example, the generative model identifies an item in the order having a maximum amount of attributes matching content included in the message. The online system similarly identifies an item in the order using the generative model in response to determining a type of request to associate a note to the picker with an item included in the order. The generative model generates a modification to a quantity of the identified item in the order or generates a candidate node or association with the identified item in the order when determining the action plan, with the candidate note including text content for the picker to review in conjunction with the identified item.

Based on the determined action plan, the online system generates an interface element describing the action plan for inclusion in the communication interface. The online system transmits the interface element to a user client device for presentation to the user via the communication interface. In various embodiments, the interface element comprises structured data including information describing one or more items based on the action plan and identifying the type of request, as well as other information describing the action plan. For example, the interface element includes information identifying an item included in the action request, such as a candidate item selected from an item catalog for addition to the order. The information identifying the item may be an image of the item, a name of the item, a description of the item, or any combination thereof. Additionally, the interface element includes a description of the type of request as a request to add an item and includes a quantity of the item to add to the order. Hence, the interface element describes the action for the picker to take based on the message, as well as one or more items relevant to performing the determined action.

The interface element also includes a confirmation element. For example, the confirmation element is a button or another selectable interface element. In response to the user selecting the confirmation element via the communication interface, the user device transmits a confirmation of the action plan to the online system. In response to receiving the confirmation of the action plan, the online system modifies the order based on the action plan. For example, the online system modifies the order to include a quantity of the candidate item included in the action plan. As another example, the online system modifies the order to have a modified quantity of the identified item in the order included in the action plan or modifies the order to include a candidate note in the action plan associated with the identified item included in the action plan.

The interface element identifies one or more specific items that the online system selected or identified based on the message and describes one or more modifications to the order based on the determined action plan. Presenting the interface element to the user via the communication interface allows the user to determine whether the one or more specific items selected or identified by the online system match an item the user intended to identify in the message. Further, presenting the interface element allows the user to verify that the action plan is consistent with the user’s intent from the message before the online system performs the action plan. Hence, application of the generative model to the message converts the unstructured text of the message into an action plan comprising structured data identifying one or more specific items based on the message and including specific data for modifying the order based on the message to adjust fulfillment of the order by the picker. This generation of structured data and a corresponding structured interface element reduces an amount of interaction with the communication interface by the user and by a picker fulfilling the order, decreasing power consumption by a user client device and by a picker client device, while also reducing an amount of data transmitted between the user client device and the picker client device via the network.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with one or more embodiments.

FIG. 3 illustrates a flowchart of a method for generating a user interface element comprising structured data through application of a generative model to unstructured text received via a communication interface, in accordance with one or more embodiments.

FIG. 4 illustrates a process flow diagram of a method for generating a user interface element comprising structured data through application of a generative model to unstructured text received via a communication interface, in accordance with one or more embodiments.

### DETAILED DESCRIPTION

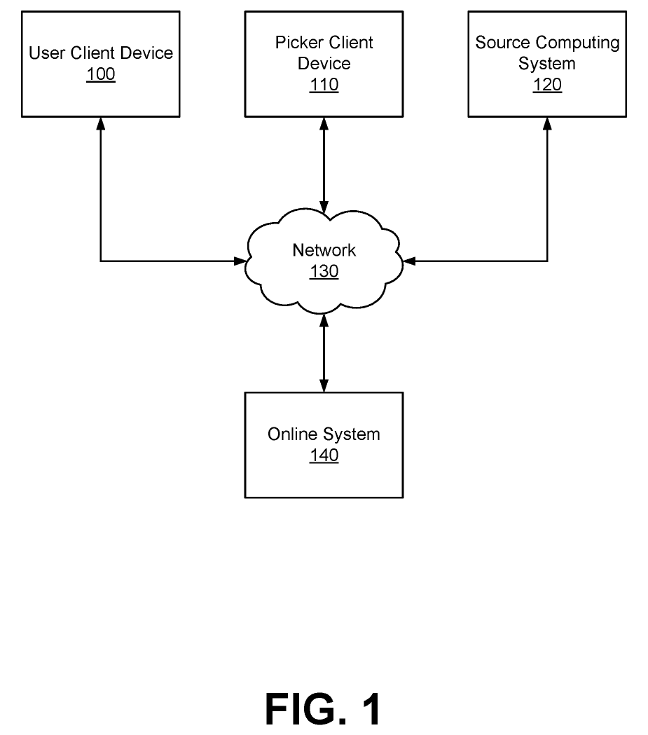

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120.

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a time frame during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user’s order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user’s order to the picker in a collection interface. The collection interface is a user interface that provides information to the picker on which items to collect for a user’s order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user’s order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker’s location. For example, if the picker takes a wrong turn while traveling to a delivery location, the online system 140 determines the picker’s updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. Patent Application No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities. Additionally, the source computing system 120 may receive payment information from the online system 140 for orders serviced by the online system 140. Alternatively, the source computing system 120 may provide payment to the online system 140 for some portion of the overall cost of a user’s order (e.g., as a commission).

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 is an online system by which users can order items to be provided to them by a picker from a source. The online system 140 receives orders from a user client device 100 through the network 130. The online system 140 selects a picker to service the user’s order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source.

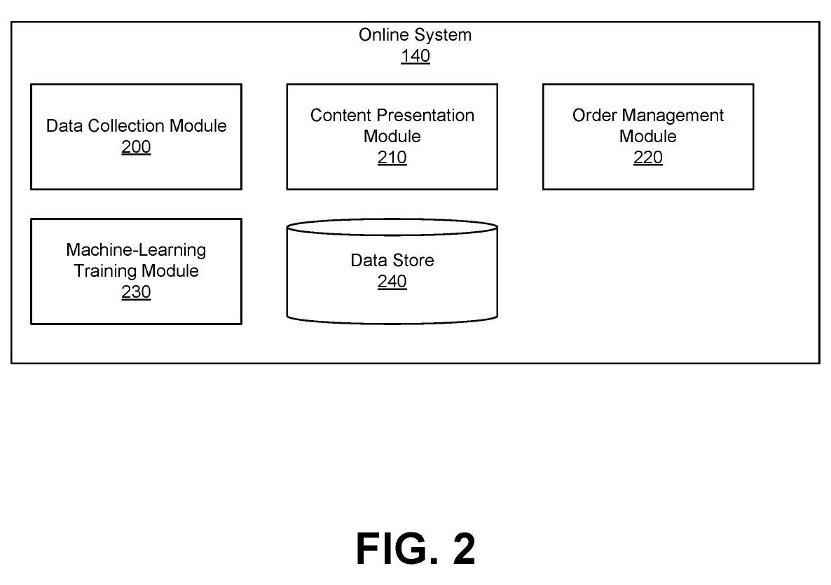

As an example, the online system 140 may allow a user to order groceries from a grocery store source. The user’s order may specify which groceries they want to be delivered from the grocery store and the quantities of each of the groceries. The user’s client device 100 transmits the user’s order to the online system 140 and the online system 140 selects a picker to travel to the grocery store source location to collect the groceries ordered by the user. The online system transmits an offer to the picker for the picker to service the order in exchange for consideration and, if the picker accepts the offer, the picker collects the groceries from the grocery store. Once the picker has collected the groceries ordered by the user, the picker delivers the groceries to a location transmitted to the picker client device 110 by the online system 140. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, an order management module 220, a machine-learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user’s name, address, shopping preferences, favorite items, or stored payment instruments. The user data also may include default settings established by the user, such as a default source/source location, payment instrument, delivery location, or delivery time frame. The data collection module 200 may collect the user data from sensors on the user client device 100 or based on the user’s interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be replacements for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker’s name, the picker’s location, how often the picker has serviced orders for the online system 140, a user rating for the picker, which sources the picker has collected items at, or the picker’s previous shopping history. Additionally, the picker data may include preferences expressed by the picker, such as their preferred sources to collect items at, how far they are willing to travel to deliver items to a user, how many items they are willing to collect at a time, time frames within which the picker is willing to service orders, or payment information by which the picker is to be paid for servicing orders (e.g., a bank account). The data collection module 200 collects picker data from sensors of the picker client device 110 or from the picker’s interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a time frame within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker’s performance for an order may be order data and picker data.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The order management module 220 manages orders for items from users. The order management module 220 receives orders from a user client device 100 and offers the orders to pickers for service based on picker data. For example, the order management module 220 offers an order to a picker based on the picker’s location and the location of the source from which the ordered items are to be collected. The order management module 220 may also offer an order to a picker based on how many items are in the order, a vehicle operated by the picker, the delivery location, the picker’s preferences on how far to travel to deliver an order, the picker’s ratings by users, or how often a picker agrees to service an order.

In some embodiments, the order management module 220 determines when to offer an order to a picker based on a delivery time frame requested by the user with the order. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested time frame. Thus, when the order management module 220 receives an order, the order management module 220 may delay offering the order to a picker if the requested time frame is far enough in the future (i.e., the picker may be offered the order at a later time and is still predicted to meet the requested time frame).

When the order management module 220 offers an order to a picker, the order management module 220 transmits the order to the picker client device 110 associated with the picker. The order management module 220 may also transmit navigation instructions from the picker’s current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user’s order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The user client device 100 and the picker client device 110 make use of a communication interface for generating messages comprising unstructured text and for transmitting the messages. A message from a communication interface is received by the order management module 220, which routes the message to a recipient. For example, the communication interface is accessible while a picker fulfills an order, so the order management module 220 determines an order corresponding to a combination of a picker and a user exchanging messages via one or more communication interfaces. When a picker is fulfilling an order, messages from a user from whom the order was received may include modifications to the order. For example, a message from the user may request that the picker obtain additional items that were not included in the order while fulfilling the order or request that the picker obtain a different quantity of an item than was previously specified by the order.

However, messages received from a user via the communication interface comprise unstructured text. While this simplifies message creation, use of unstructured text can create ambiguity about one or more items a user is referring to in a message. For example, a message from a user includes one or more attributes of an item or a generic description of the item rather than the specific item. When fulfilling an order, the picker obtains specific items, so when a message includes a generic description of an item or attributes of an item, the picker obtains additional information from the user to identify a specific item relevant to the message. This acquisition of additional information from the user increases an amount of time for the picker to fulfill the order, and increases an amount of data exchanged between a user client device 100 of the user and a picker client device 110 of the picker, while increasing an amount of power consumed by the picker client device 110 presenting the communication interface.

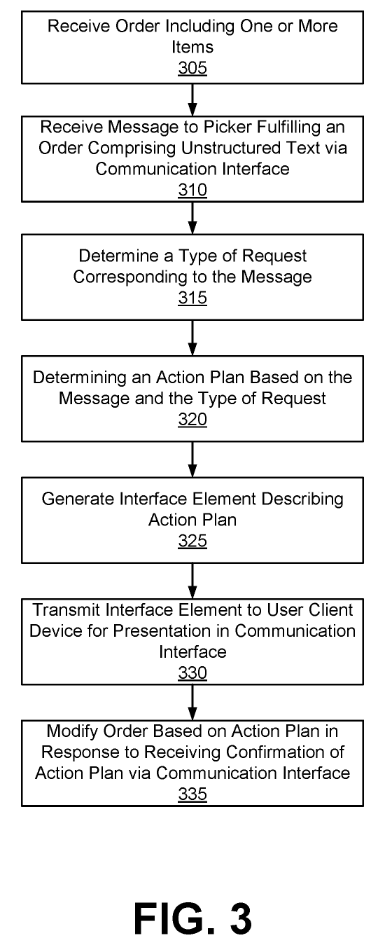

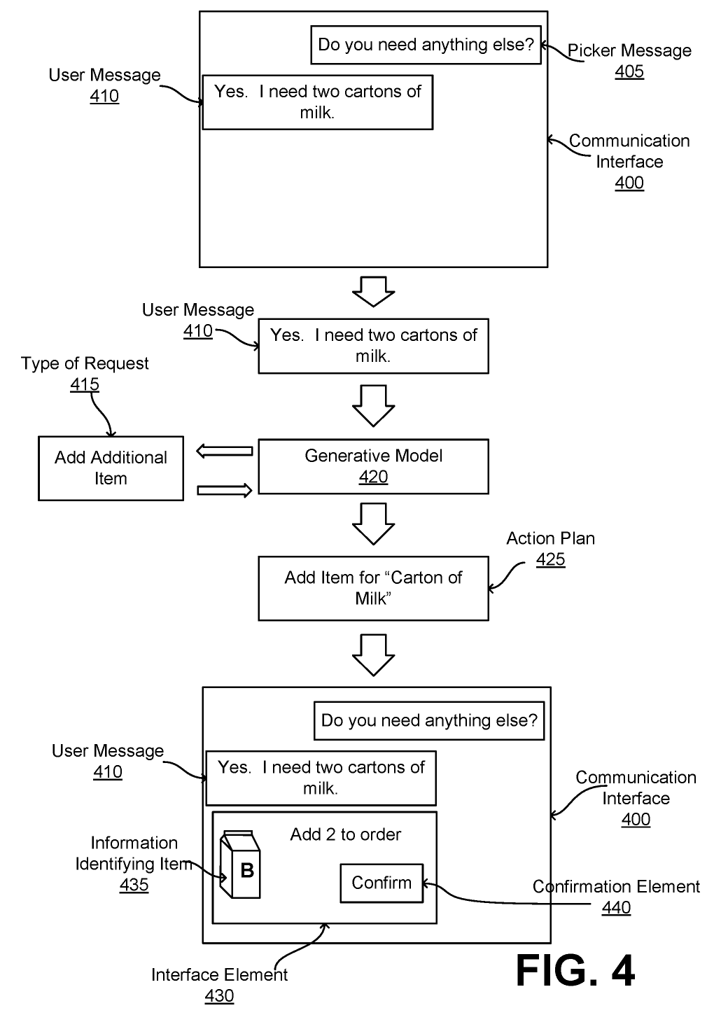

To simplify modification of an order being fulfilled through the communication interface, when the order management module 220 receives a message from a user whose order is being fulfilled by a picker, the order management module 220 may determine a type of request based on the message. In various embodiments, the order management module 220 maintains a set of types of requests that each correspond to different actions to be performed by a picker. For example, a type of request may identify inclusion of an additional item to an order, while another type of request may identify a modification to a quantity of an item in the order. In another example, a type of request may identify an addition of a note associated with an item to the order. As further described below in conjunction of FIGS. 3 and 4, the order management module 220 may apply a generative model, such as a large language model (LLM), to a message to determine a type of request corresponding to the message.

As further described below in conjunction with FIGS. 3 and 4, the order management module 220 may determine an action plan for the message. The action plan comprises structured data for an action to be performed by the picker. In various embodiments, the action plan comprises multiple fields, with a value associated with each field. One or more of the fields are determined based on the type of action determined for the message, so a plan of action includes different data depending on the type of request determined for the message. As further described below in conjunction with FIGS. 3 and 4, the order management module 220 applies the generative model to the type of request and to the message to determine values for different fields comprising the action plan. Subsequently, the order management module 220 generates an interface element describing the action plan for presentation to the user via the communication interface. The interface element comprises structured data describing an action to be performed by the picker and one or more items involved with the action, as well as information relevant to performance of the action, as further described below in conjunction with FIGS. 3 and 4. In response to receiving a confirmation of the action plan from an interaction by the user, such as an interaction with the interface element via the communication interface, the order management module 220 modifies the order based on the action plan to include modifications determined from the message.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 230 trains machine-learning models used by the online system 140. The online system 140 may use machine-learning models to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 230 generates the set of parameters (e.g., the particular values of the parameters) for a machine-learning model by “training” the machine-learning model. Once trained, the machine-learning model uses the set of parameters to transform inputs into outputs.

The machine-learning training module 230 trains a machine-learning model based on a set of training examples. Each training example includes input data to which the machine-learning model is applied to generate an output. For example, each training example may include user data, picker data, item data, or order data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 230 may apply an iterative process to train a machine-learning model whereby the machine-learning training module 230 updates parameter values of the machine-learning model based on each of the set of training examples. The training examples may be processed together, individually, or in batches. To train a machine-learning model based on a training example, the machine-learning training module 230 applies the machine-learning model to the input data in the training example to generate an output based on a current set of parameter values. The machine-learning training module 230 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 230 updates the set of parameters for the machine-learning model based on the score generated by the loss function. For example, the machine-learning training module 230 may apply gradient descent to update the set of parameters.

The machine-learning training module 230 trains or obtains one or more generative models in some embodiments. A generative model, such as a large language model (LLM), receives an input including a prompt and generates output based on the received input. For example, a generative model is a large language model (LLMs) previously trained on a large text corpus to learn relationships between different portions of text, such as between different words. Based on the previously learned relationships, the LLM generates output text from text received as input based on a prompt received as input. For example, a generative model receives a prompt including one or more formatting instructions and text data as input and generates output text in a format specified by the one or more formatting instructions and based on the input text and previously learned relationships between various text.

In some embodiments, the machine-learning training module 230 may retrain the machine-learning model based on the actual performance of the model after the online system 140 has deployed the model to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 230 re-trains the machine-learning model using the additional training data, using any of the methods described above. This deployment and re-training process may be repeated over the lifetime use for the machine-learning model. This way, the machine-learning model continues to improve its output and adapts to changes in the system environment, thereby improving the functionality of the online system 140 as a whole in its performance of the tasks described herein.

The data store 240 stores data used by the online system 140. For example, the data store 240 stores user data, item data, order data, and picker data for use by the online system 140. The data store 240 also stores trained machine-learning models trained by the machine-learning training module 230. For example, the data store 240 may store the set of parameters for a trained machine-learning model on one or more non-transitory, computer-readable media. The data store 240 uses computer-readable media to store data, and may use databases to organize the stored data.

FIG. 3 is a flowchart of a method for generating a user interface element comprising structured data through application of a generative model to unstructured text received via a communication interface, in accordance with some embodiments. Alternative embodiments may include more, fewer, or different steps from those illustrated in FIG. 3, and the steps may be performed in a different order from that illustrated in FIG. 3. These steps may be performed by an online system (e.g., online system 140). Additionally, each of these steps may be performed automatically by the online system 140 without human intervention.

An online system 140, such as an online concierge system, receives 305 orders from various users. An order identifies one or more items as well as a source for obtaining the identified items. Further, the order may include information about fulfilling the order, such as a time interval for the user to receive items from the order and a location to which items are to be provided after being obtained from the identified source. Additional or alternative information may be included in the order in various embodiments.

The online system 140 allocates an order to a picker, who obtains items included in the order and delivers the obtained items to a location identified by the order. In various embodiments, the online system 140 presents attributes of an order to a picker, and the picker determines whether to select the order for fulfillment based on the attributes. In response to receiving a selection of an order from a picker, the online system 140 allocates the order to the picker for fulfillment.

As the picker fulfills the order, the online system 140 enables the user and the picker to communicate with each other through a communication interface. As further described above in conjunction with FIG. 2, the communication interface allows the user to input a text-based message via the communication interface on user client device 100 that is transmitted via the online system 140 and the network 130 to a picker client device 110 of the picker and presented or displayed to the picker (e.g., via a display of picker client device 110). Similarly, the picker client device 110 may send a text-based message via the communication interface from the picker that is transmitted via the online system 140 and the network 130 to the user client device 100 for presentation to the user. In various embodiments, messages received via the communication interface comprise unstructured text to simplify creation of messages by the user and the picker.

Transmitting a message to a picker via the communication interface allows the user to provide the picker with modifications to the order being fulfilled by the picker. However, exchanging unstructured text between the user and the picker comprise unstructured text increases a likelihood of ambiguity between the picker and the user during order fulfillment. A message from the user may include attributes of an item or a generic description of the item rather than the item itself. A picker might not be able to perform an action corresponding to the message without identifying a specific item corresponding to attributes or a generic description in a message, and the picker may identify a different specific item from the content of a message than an item the user refers to via the message. For example, a message from the user requests the picker add “bread” to the items included in the order, but does not identify a specific item categorized as “bread” for the picker to add to the order. In conventional implementations, the picker transmits additional messages to the user to identify a particular item to include in the order to satisfy the user’s request for “bread,” or to resolve other ambiguities in a message from the user. This increases an amount of time the picker exchanges data with the user through the picker client device 110, increasing power and computing resource consumption by the picker client device 110 and increases an amount of input the picker and the user provide via the communication interface, increasing a length of time the picker and the user interact with their respective communication interfaces to modify the order. This increases an amount of time for the picker to fulfill an order, which decreases a likelihood of the user subsequently creating additional orders for fulfillment by the online system 140.

To reduce interaction with the communication interface when a user identifies one or more modifications to the order, when the online system 140 receives 310 a message to the picker fulfilling the order comprising unstructured text via the communication interface, the online system 140 determines 315 a type of request corresponding to the message. Because the message comprises unstructured text, different text included in the message may be used to convey a common action for the picker to perform when fulfilling the order. To simplify determination of an action for the picker to perform based on a message, the online system 140 maintains a set of types of requests, with each type of request identifying a specific action to be performed by the picker. Example types of requests include: a request to add an item to the order, a request to modify one or more items included in the order (e.g., increase a quantity of an item to obtain, decrease a quantity of an item to obtain), and a request to add one or more notes for obtaining an item for the picker. However, in other embodiments, different or additional types of requests may be maintained or identified by the online system 140.

In various embodiments, the online system 140 applies a generative model, such as a large language model (LLM), to the unstructured text comprising the message to determine 315 the type of request based on the unstructured text comprising the message. For example, the generative model receives a prompt comprising the message and an instruction to identify a type of request from the unstructured text comprising the message. As further described above in conjunction with FIG. 2, the generative model is pre-trained through application to a training corpus including unstructured text obtained from various sources to learn relationships between different portions of text. Based on the previously learned relationships, the generative model generates output text identifying a type of request from the unstructured text of the message received as an input.

In various embodiments, the online system 140 tunes the generative model to determine 315 the type of request using supplemental examples based on unstructured text corresponding to different types of requests. The online system 140 generates an embedding for each supplemental example and maintains an index that includes supplemental examples, or embeddings for supplemental examples, associated with corresponding types of requests in some embodiments. The index provides an intermediate representation of supplemental examples in the form of their embeddings rather than text comprising different supplemental examples in various embodiments. Other forms of indices may be used to represent unstructured text corresponding to different types of requests. The online system 140 generates an embedding for the message and determines measures of similarity (e.g., cosine similarity, dot product) between the embedding for the messages and the embeddings for supplemental examples in the index. Based on the measures of similarity, the online system 140 identifies one or more supplemental examples from the index. For example, the online system 140 identifies embeddings of supplemental examples having at least a threshold measure of similarity to the embedding for the message. As another example, the online system 140 ranks supplemental examples based on measures of similarity between their embeddings and the embedding of the message and identifies one or more supplemental examples having at least a threshold position of the ranking. The online system 140 includes the one or more identified supplemental examples, or embeddings for the one or more identified supplemental examples, in the prompt for the generative model along with the message and the instruction to identify the type of request. Based on the embeddings of the one or more identified supplemental examples and the message in the prompt, the generative model determines 315 the type of request corresponding to the message.

Based on the type of request determined 315 for the message and the message, the online system 140 determines 320 an action plan for the picker. The action plan comprises structured data for inclusion in the order to present to the picker fulfilling the order. For example, an action plan includes multiple fields and one or more values for each field. The fields and associated values provide specific information for a picker identifying a specific action to perform and information for performing the specific action. For example, an action plan includes a field specifying the type of request, a field specifying an identifier of an item, a field specifying a quantity of the item, and one or more fields specifying one or more attributes of the item. Other fields and corresponding specific data may be included in the action plan in various embodiments. The type of request determines data that the online system 140 obtains and includes in the action plan, so determining 315 the type of request affects what data the online system 140 obtains and includes in the action plan.

In various embodiments, the online system 140 determines 320 the action plan by applying the generative model to a prompt including the type of request, at least a portion of the message, and one or more instructions. Alternatively, the online system 140 determines an instruction for the prompt based on the type of request, so the prompt includes the determined instruction and at least a portion of the message. The online system 140 may iteratively apply the generative model to a sequence of prompts to determine 320 the action plan in some embodiments. In the preceding example, a prompt may be based on an output of the generative model based on a previously received prompt.

Based on the determined action plan, the online system 140 generates 325 an interface element describing the action plan for inclusion in the communication interface. As further described below, the interface element comprises structured data including information describing the action plan, such as an action to be performed by the picker and one or more items relevant to the action to be performed. Additionally, the interface element includes a confirmation element for presentation to the user and configured to receive interaction from the user. Hence, the interface element provides a structured set of information describing the action plan to the user, simplifying the user reviewing the action plan for consistency with the user’s intended action for the picker.

The online system 140 transmits 330 the interface element to the user client device 100 via the network 130 for presentation to the user via the communication interface (e.g., on a display of the user client device 100). For example, the communication interface renders the interface element as a message in the communication interface. The interface element displays descriptive information about the action plan determined 320 by the online system 140 based on the received message. For example, the interface element identifies an action to be performed corresponding to the type of request determined 315 by the online system 140 for the message and includes information describing one or more items the online system 140 determined are applicable to the action to be performed based on the message. Hence, the interface element identifies one or more specific items that the online system 140 identified based on the message and the action the online system 140 determined for the picker to perform based on the message, allowing the user to determine whether the one or more identified items selected or identified by the online system 140 match one or more items to which the user was referring in the message. Further, identifying the type of action plan via the interface element allows the user to verify the action to be performed by the picker that the online system 140 determined based on the message is consistent with the user’s intent from the message before the action is performed.

In response to receiving a confirmation of the action plan from the user via the communication interface, the online system 140 modifies 335 the order based on the determined action plan. For example, the user selects a confirmation element included in the interface element to confirm the action plan described by the interface element. The user client device 100 transmits the confirmation of the action plan to the online system 140 in response to receiving the selection of the confirmation element. In response to receiving the confirmation, the online system 140 modifies 335 the order based on the action plan. For example, the online system 140 includes an additional item identified by the interface element in the order, along with a quantity of the additional item. As further examples, the online system 140 modifies a quantity of one or more items currently in the order and identified by the interface element or adds a note to the picker in association with an item identified by the interface element to the order. However, other modifications to the order may be performed by the online system 140 in response to other types of requests being determined 315. For purposes of illustration, examples of different action plans and corresponding modifications to the order based on the action plans are further described below.

In response to determining 315 the type of request comprises a request to add an additional item to the order, the online system 140 selects one or more additional items to add to the order based on the message to determine 320 the action plan. To select one or more additional items based on the message, the online system 140 generates a search query based on the message. The search query includes portions of the unstructured text included in the message as one or more attributes of the additional item. In various embodiments, the online system 140 applies the generative model to a prompt including the message along with an instruction to generate a search query from text comprising the message . Based on relationships previously learned between different portions of text, the generative model extracts one or more attributes of items from the message and generates the search query including the extracted one or more attributes.

Based on the generated search query from the message, the online system 140 retrieves a set of candidate items accessible to the online system 140, with each candidate item having one or more attributes at least partially matching the attributes in the search query. In various embodiments, the online system 140 retrieves an item catalog including items available from a source identified by the order and compares attributes of items in the item catalog to attributes included in the search query. Items from the item catalog for the source identified in the order having attributes that at least partially match one or more attributes included in the search query are retrieved as candidate items, so the candidate items are retrieved based on the attributes included in the search query.

The online system 140 selects one or more items of the set of candidate items for the action plan. In various embodiments, the online system 140 determines a search query embedding for the generated search query and retrieves item embeddings for each of at least the candidate items. An item embedding for a candidate item is based on one or more attributes of the item maintained by the online system 140. The online system 140 determines a measure of similarity (e.g., dot product, cosine similarity) between the generated search query and each item embedding of the set of items. In some embodiments, the online system 140 ranks the candidate items based on the measures of similarity and selects one or more candidate items having at least a threshold position in the ranking (e.g., having a maximum position in the ranking). Alternatively, the online system 140 selects a candidate item having an item embedding with a maximum measure of similarity to the search query embedding or selects one or more candidate items having item embeddings with at least a threshold measure of similarity to the search query embedding.

Additionally, the online system 140 accounts for predicted availability of candidate items of the set when selecting one or more candidate items. As further described above in conjunction with FIG. 2, the online system 140 maintains an availability model that determines a predicted availability of an item at a source. In various embodiments, the availability model comprises a machine-learning model trained to predict an availability of an item at a source identified to the availability model. The availability model may be trained to predict a likelihood that an item is available at a source or may predict an estimated number of items that are available at the source. In various embodiments, the online system 140 filters the set of candidate items based on predicted availability of the candidate items. For example, the online system 140 removes candidate items having less than a threshold predicted availability at the source identified by the order from the set. The online system 140 selects one or more of the candidate items of the filtered set based on measures of similarity between the search query embedding and item embeddings for candidate items in the filtered set. This prevents the online system 140 from selecting one or more candidate items that have less than a threshold predicted availability at the source, increasing a likelihood of the selected one or more candidate items being available at the source.

Further, the online system 140 may account for items included in orders previously fulfilled for the user when selecting one or more candidate items. In various embodiments, the online system 140 modifies the set of candidate items based on a number of prior orders fulfilled for the user including various candidate items or based on a frequency with which prior orders fulfilled for the user included various candidate items. The online system 140 may filter the set of candidate items based on a threshold number of prior orders including candidate items or based on a threshold frequency with which different candidate items were included in prior orders fulfilled for the user. The online system 140 selects one or more of the candidate items of the filtered set based on measures of similarity between the search query embedding and item embeddings for candidate items in the filtered set in some embodiments.

Alternatively, the online system 140 generates a score for each candidate item of the set, with a score for a candidate item of the set based on one or more selected from a group consisting of: a measure of similarity between the search query embedding and an item embedding for the candidate item, a predicted availability of the candidate item at the source included in the retailer, a frequency with which the user included the candidate item in prior orders fulfilled for the user, and a number of prior orders fulfilled for the user including the candidate item. The online system 140 selects one or more candidate items based on their scores. For example, the online system 140 ranks candidate items based on their scores and selects one or more candidate items having at least a threshold position in the ranking.

The online system 140 generates 325 the interface element describing the action plan to add one or more selected items to the order. In various embodiments, the interface element includes information describing a selected item, such as an image or a name of the selected item, and includes a description of the action plan to identify an action to be performed by the picker. In this example, the description indicates the picker is to add the selected item to the order. The interface element may include a quantity of the selected item being added to the order, with the quantity determined based on the message from the user, such as through application of the generative model to the message. Further, the interface element includes additional attributes of the selected item in some embodiments. Example additional attributes of the selected item include a price of the selected item from the source, sizing information of the selected item, or other attributes of the selected item. The interface element also includes a confirmation element displayed in conjunction with the information describing the action plan. In response to receiving a confirmation of the action plan from the user selecting the confirmation element, the online system 140 modifies 335 the order being fulfilled by the picker to include the selected item that was identified by the interface element. In other embodiments, the online system 140 receives confirmation of the action plan through another input from the user, such as by receiving a confirmation message through the communication interface from the user. Modifying the order in response to receiving confirmation of the action plan allows the picker to more easily identify one or more items added to the order by the action plan through reviewing the order itself, rather than reviewing both the order and the communication interface.

In response to determining 315 the type of request comprises a request to modify an item in the order, the online system 140 identifies identifying the item identified by the message within the order to determine 320 the action plan. As the unstructured text of the message may include a generic description of the item or one or more attributes of the item rather than the specific item to modify, the online system 140 leverages the generative model to identify an item included in the order corresponding to the message. For example, the online system 140 applies the generative model to a prompt including at least a portion of the unstructured text from the message and an instruction to identify an item within the order based on the message. In various embodiments, the generative model identifies an item within the order having at least a threshold amount of attributes matching data in the message.

As different types of modifications may be made to an item included in the order, the online system 140 also applies the generative model to a prompt including the unstructured text comprising the message and an instruction to identify a type of modification to the item in the order from the message. Example modifications to an item in the order include removing the item from the order or changing a quantity of the item included in the order. The generative model outputs a type of modification to the order, as well as information for performing the type of modification, from the message. Information for performing the type of modification includes an updated quantity of the item to include in the order, or one or more other attributes of the order to change. For example, the generative model outputs a type of modification specifying a change in quantity of an item and an updated quantity based on the change.

The online system 140 generates 325 an interface element including information describing the identified item from the order and the type of modification to the order. For example, the interface element includes an image and a name of the identified item and a description of the modification to the item in the order. If the type of modification is a change in quantity of the identified item in the order, the interface element includes an updated quantity of the identified item based on the message. If the type of modification is a removal of the identified item from the order, the interface element specifies that the identified item is being removed from the order. The interface element also includes a confirmation element displayed in conjunction with the information describing the action plan. In response to receiving a confirmation of the action plan from the user selecting the confirmation element, the online system 140 modifies 335 the order being fulfilled by the picker to include the updated quantity of the identified item in the order. In other embodiments, the online system 140 receives confirmation of the action plan through an alternative input from the user, such as by receiving a confirmation message from the user via the communication interface. Modifying the order to include the updated quantity allows the picker to determine the updated quantity based on the order itself, rather than by reviewing the order and the communication interface.

In response to determining 315 the type of request comprises a request to generate a note to the picker associated with an item included in the order, the online system 140 identifies the item within the order identified by the message to determine 320 the action plan. As the unstructured text of the message may include a generic description of the item or one or more attributes of the item rather than the specific item with which the note is associated, the online system 140 leverages the generative model to identify an item included in the order corresponding to the message. For example, the online system 140 applies the generative model to a prompt including at least a portion of the unstructured text from the message and an instruction to identify an item within the order based on the message. For example, the generative model identifies an item within the order having at least a threshold amount of attributes matching data in the message.

Additionally, the online system 140 generates a note for the picker associated with the identified item based on the message. The note includes instructions for the picker to obtain the items, such as physical characteristics of the item to be obtained, specific attributes of the item to be obtained, or user-specific preferences for the item to be obtained. In various embodiments, the online system 140 applies the generative model to a prompt including at least a portion of the message and an instruction to generate a note for the shopper from the unstructured text in the message. The candidate note includes one or more portions of the message. Using the generative model to generate the candidate note allows the online system 140 to provide standardized content or standardized formatting for notes associated with items presented to various pickers, simplifying review of notes associated with items by various pickers.

The online system 140 generates 325 an interface element including information describing the action plan that includes the item identified from the order and the candidate note. For example, the interface element includes an image and a name of the identified item and text comprising the candidate note associated with the identified item. The interface element also includes a confirmation element displayed in conjunction with the information describing the action plan. In response to receiving a confirmation from the user selecting the confirmation element, the online system 140 modifies 335 the order being fulfilled by the picker to include the updated quantity of the identified item in the order. In other embodiments, the online system 140 receives confirmation of the action plan through another input from the user, such as by receiving a confirmation message from the user via the communication interface. Modifying the order to associate the candidate note with the identified item allows the picker to review the candidate note based on the order itself, rather than by reviewing the order and the communication interface.

In various embodiments, the user performs one or more alternative interactions with the communication interface in response to being presented with the interface element to modify the action plan described by the interface element. For example, the user generates one or more messages including modifications to the action plan via the communication interface. The online system 140 updates the action plan based on the modifications from the one or more messages and generates an updated interface element describing the updated action plan to the user via the communication interface, as further described above. This allows the user to adjust the action plan determined 320 via the communication interface, allowing the user to refine the action plan to more accurately reflect the intent of the user for modifying the order.

FIG. 4 is a process flow diagram of a method for generating a user interface element comprising structured data through application of a generative model to unstructured text received through a communication interface, in accordance with some embodiments. As further described above in conjunction with FIG. 3, an online system 140 system receives orders from various users. An order identifies one or more items as well as a source for obtaining the identified items. Further, the order may include information about fulfilling the order, such as a time interval for the user to receive items from the order and a location to which items from the order are to be provided after being obtained from the identified source. Additional or alternative information may be included in the order in various embodiments.

The online system 140 allocates an order to a picker, who obtains items included in the order and delivers the obtained items to a location identified by the order. While the picker fulfills the order, the online system 140 enables the picker and the user to communicate with each other through a communication interface. Using a user client device 100, the user creates a text-based message through the communication interface that the user client device 100 transmits to the picker client device 110. A communication interface on the picker client device 110 presents the message to the picker and allows the picker to create a text-based message that is transmitted to the user client device 100. Messages generated through the communication interface are unstructured text, simplifying message creation by the user and by the picker to reduce an amount of time for the user and the picker to exchange messages.

Messages from the user to the picker while the picker is fulfilling an order allow the user to identify modifications to the order, allowing the user to adjust how the picker fulfills the order through one or more messages. For example, a message from the user to the picker requests the picker obtain an additional item while fulfilling the order. As another example, a message from the user to the picker or requests the picker obtain a different quantity of an item included in the order.

While having the picker and the user compose messages through unstructured text simplifies message composition, using unstructured text increases ambiguity in communication between the picker and the user during order fulfillment. For example, a message from a user includes a generic description of an item or attributes of an item rather than a specific item the picker is capable of obtaining from the source. In an example, a message from the user requests the picker to also obtain “milk” in addition to the items included in the order, but does not identify a specific milk item to obtain. Conventionally, the picker resolves such ambiguity by transmitting additional messages to the user identifying one or more specific items available from the source that have attributes at least partially matching content from the message from the user or by transmitting additional messages that request more specific information from the user. This increases an amount of data exchanged between the picker client device 110 and the user client device 100, which increases the bandwidth of the network 130 used by the user device 100 and the picker client device 110. Further, an increased number of messages exchanged between the user client device 100 and the picker client device 110 increases an amount of time the picker client device 110 and the user client device 100 display the communication interface, which increases power consumption by the picker client device 110 and by the user client device 100. Additionally, exchanging a larger number of messages between the picker and the user while the picker fulfills an order increases a length of time the picker and the user interact with their respective communication interfaces, which increases an amount of time for the piker to fulfill the order.

For purposes of illustration, FIG. 4 shows an example communication interface 400 displaying a picker message 405 that the online system 140 received from a picker fulfilling an order. Similarly, the communication interface 400 displays a user message 410 the online system 140 received from a user. For purposes of illustration, the user message 410 includes a request for the picker to obtain an additional item that was not included in the order that the picker is fulfilling. However, the user message 410 in FIG. 4 does not identify a specific item to obtain, but instead includes a generic description of “milk” as the additional item for the picker to obtain. Conventionally, the picker would provide additional picker messages, and the user would provide additional user messages to the picker to ascertain a specific item to obtain to satisfy the generic item description included in the user message 410.

To reduce interaction with the communication interface 400 for a user to convey more modifications to the order to the picker fulfilling the order, the online system 140 determines a type of request 415 corresponding to the user message 410. Example types of requests include: a request to add an item to the order, a request to modify one or more items included in the order (e.g., increase a quantity of an item to obtain, decrease a quantity of an item to obtain), and a request to add one or more notes for obtaining an item for the picker. However, in other embodiments, different or additional types of requests may be maintained or identified by the online system 140. Different types of requests 415 correspond to different types of actions for the picker to perform for the order. Maintaining different types of requests 415 allows the online system 140 to maintain a set of actions for fulfilling an order.

As further described above in conjunction with FIG. 3, in various embodiments, the online system 140 uses a generative model 420, such as a large language model (LLM), to determine the type of request 415 for the user message 410. For example, the online system 140 generates a prompt for the generative model 420 that includes the user message 410 and an instruction to identify a type of request 415 based on the text included in the user message 410. The generative model 420 is pre-trained through application to a training corpus that includes unstructured text obtained from various sources to learn relationships between different portions of text. Based on the previously learned relationships, the generative model 420 generates output text comprising a type of request 415 from the unstructured text of the user message 410 the generative model 420 received as an input.

In various embodiments, the online system 140 tunes the generative model 420 to determine the type of request 415 using supplemental examples comprising unstructured text corresponding to different types of requests. For example, the online system 140 generates an embedding for each supplemental example and maintains an index including supplemental examples associated with corresponding types of requests, in some embodiments. The index provides an intermediate representation of supplemental examples in the form of their embeddings rather than text comprising different supplemental examples in various embodiments. The online system 140 generates an embedding for the user message 410 and determines measures of similarity (e.g., cosine similarity, dot product) between the embedding for the user message 410 and the embeddings for supplemental examples in the index. For example, the online system 140 identifies embeddings of supplemental examples having at least a threshold measure of similarity to the embedding for the user message 410. As another example, the online system 140 ranks supplemental examples based on measures of similarity between their embeddings and the embedding of the message and selects one or more supplemental examples having at least a threshold position in the ranking. The online system 140 includes the one or more selected supplemental examples, or embeddings for the one or more selected supplemental examples, in the prompt for the generative model 420 along with the user message 410 and the instruction to identify the type of request 415. Based on the embeddings of the one or more selected supplemental examples and the user message 410 in the prompt, the generative model 420 determines the type of request 415 corresponding to the user message 410. In the example of FIG. 4, the online system determines the user message 410 is a type of request 415 for the picker to add an additional item to the order.

The online system 140 determines an action plan 425 for the picker based on the type of request 415 and the unstructured text in the user message 410. The action plan 425 comprises structured data based on the user message 410. In various embodiments, the action plan 425 includes specific fields and values for each of the fields that the online system 140 determines based on the user message 410. For example, the action plan 425 includes a field including the type of request 415 and one or more additional fields, and associated values, based on the type of request 415. For example, the additional fields include values for an item identifier, for a quantity of an item, text for association with an item, or other data relevant to the picker performing an action described by the action plan 425 when fulfilling the order. Having the action plan 425 comprise structured data allows the online system 140 provides the picker with standardized information based on the unstructured text from the user message 410, allowing the picker to more easily determine one or more actions to perform based on the user message 410, as well as one or more items relevant to the one or more actions to perform.

In various embodiments, the online system 140 determines the action plan 425 by applying the generative model 420 to a prompt including at least a portion of the user message 410 and the type of request 415. The type of request 415 affects data that the online system 140 obtains for in the action plan 425, so the type of request 415 determines one or more fields included in the action plan 425. For example, a type of request 415 to add an additional item to the order, as in the example of FIG. 4, causes the online system 140 to select one or more candidate items for inclusion in the order based on the user message 410. As further described above in conjunction with FIG. 3, to determine the action plan 425 for a type of request 415 to add one or more additional items to the order shown in the example of FIG. 4, the online system 140 generates a search query based on the user message 410 using the generative model 420. Based on the search query, the online system 140 retrieves a set of candidate items from an item catalog of items accessible from a source included in the order. For example, each candidate item has one or more attributes that at least partially match the search query. The online system 140 selects one or more of the candidate items and includes the selected one or more candidate items in the action plan 425, as further described above in conjunction with FIG. 3. The generative model 420 may determine other data for the action plan 425 from the user message 410, such as a quantity of a candidate item to obtain based on the user message 410.

As another example, a type of request 415 to modify one or more items included in the order causes the online system 140 to retrieve the order and to identify an item in the order based on the user message 410. The online system 140 applies the generative model 420 to a prompt including the order, or the items in the order, and the user message 410 to identify the item in the order corresponding to the user message 410. For example, the generative model 420 identifies an item in the order having a maximum amount of attributes matching content included in the user message 410. The online system 140 similarly identifies an item in the order using the generative model 420 in response to determining a type of request 415 to associate a note to the picker with an item included in the order. The generative model 420 generates a modification to a quantity of the identified item in the order or generates a candidate node or association with the identified item in the order when determining the action plan 425, as further described above in conjunction with FIG. 3.

Based on the determined action plan 425, the online system 140 generates an interface element 430 describing the action plan 425 for inclusion in the communication interface 400. The online system 140 transmits the interface element 430 to a user client device 100 for presentation to the user via the communication interface 400. In various embodiments, the interface element 430 comprises structured data including information describing one or more items based on the action plan 425 and identifying the type of request 415, as well as other information describing the action plan 425. In the example of FIG. 4, the interface element 430 includes information 435 identifying an item included in the action request, such as a candidate item selected from an item catalog for addition to the order. The information 435 identifying the item may be an image of the item, a name of the item, a description of the item, or any combination thereof. Additionally, in the example of FIG. 4 the interface element 430 includes a description of the type of request 415 as a request to add an item and includes a quantity of the item to add to the order. Hence, the interface element 430 describes the action for the picker to take based on the user message 410, s well as one or more items relevant to performing the determined action.

The interface element 430 also includes a confirmation element 440. For example, the confirmation element 440 is a button or another selectable interface element. In response to the user selecting the confirmation element 440 via the communication interface 400, the user device 100 transmits a confirmation of the action plan 425 to the online system 140. In response to receiving the confirmation of the action plan 425, the online system 140 modifies the order based on the action plan 425. For example, the online system 140 modifies the order to include a quantity of the candidate item included in the action plan 425. As another example, the online system 140 modifies the order to have a modified quantity of the identified item in the order included in the action plan 425 or modifies the order to include a candidate note in the action plan associated with the identified item included in the action plan 425.

The interface element 430 identifies one or more specific items that the online system 140 selected or identified based on the user message 410 and describes one or more modifications to the order based on the determined action plan 425. Presenting the interface element 430 to the user via the communication interface 400 allows the user to determine whether the one or more specific items selected or identified by the online system 140 match an item the user intended to identify in the user message 410. Further, presenting the interface element 430 allows the user to verify that the action plan 425 is consistent with the user’s intent from the user message 410 before the online system 140 performs the action plan. Hence, application of the generative model 420 to the user message 410 converts the unstructured text of the user message 410 into an action plan 425 comprising structured data identifying one or more specific items based on the user message 410 and including specific data for modifying the order based on the user message 410 to adjust fulfillment of the order by the picker. This generation of structured data and a corresponding structured interface element 430 reduces an amount of interaction with the communication interface 400 by the user and by a picker fulfilling the order, decreasing power consumption by a user client device 100 and by a picker client device 110, while also reducing an amount of data transmitted between the user client device 100 and the picker client device 110 via the network 130.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium, the method comprising:
maintaining an order associated with a user, the order assigned to a picker and comprising a list of items;
establishing a communication interface between a user device of the user and a picker device of the picker, wherein the communication interface enables messaging between the user device and the picker device;
receiving, from the user device via the communication interface, a user request message comprising unstructured text;
prompting, with a first prompt, one or more generative models to identify a type of request corresponding to the user request message , the first prompt comprising at least a portion of the unstructured text of the user request message and an instruction to identify the type of request, the type of request comprising at least one of: a request to add an item to the order, a request to remove an item from the order, or a request to modify an item in the order;
prompting, with a second prompt, the one or more generative models to generate an action plan , the second prompt comprising at least a portion of the user request message and the identified type of request;
generating an interface element describing the action plan;
transmitting the interface element to the user device of the user via the communication interface, the transmitting causing the user device to display the interface element;
receiving a confirmation signal from the user device indicating that the user selected the interface element; and
responsive to receiving the confirmation signal, modifying the order based on the generated action plan.

2. The method of claim 1, wherein prompting one or more generative models to identify the type of request corresponding to the user request message based on the unstructured text of the user request message comprises:
receiving, from the one or more generative models, an output indicating that the type of request corresponding to the message is a request to add an additional item to the order.

3. The method of claim 2, wherein prompting the one or more generative models to generate the action plan comprises:
prompting the one or more generative models to identify a portion of the user request message that specifies the additional item;
generating a search query including one or more attributes of the additional item;
retrieving a set of candidate items from a search interface using the search query, each candidate item having one or more attributes at least partially matching the search query; and
selecting the additional item from the set of candidate items.

4. The method of claim 3, wherein generating the interface element describing the action plan comprises:
generating the interface element that includes the selected additional item, a quantity of the additional item, and a confirmation element to add the additional item to the order.

5. The method of claim 1, wherein prompting one or more generative models to identify a type of request corresponding to the user request message based on the unstructured text of the user request message comprises:
receiving, from the one or more generative models, an output indicating that the type of request corresponding to the message is a request to modify an item included in the order.

6. The method of claim 5, wherein prompting the one or more generative models to generate the action plan comprises:
prompting the one or more generative models to identify a portion of the user request message that identifies the item to be modified from the list of items in the order; and
prompting the one or more generative models to identify a modification to the item to be modified.

7. The method of claim 6, wherein generating the interface element describing the action plan comprises:
generating the interface element that includes the identified item to be modified, the identified modification, and a confirmation element to perform the identified modification.

8. The method of claim 5, wherein prompting one or more generative models to identify a type of request corresponding to the user request message based on the unstructured text of the user request message comprises:
receiving, from the one or more generative models, an output indicating that the type of request corresponding to the message is a request to modify an item included in the order by including a note to the picker about the item to be modified.

9. The method of claim 1, wherein prompting one or more generative models to identify a type of request corresponding to the user request message based on the unstructured text of the user request message comprises:
receiving, from the one or more generative models, an output indicating that the type of request corresponding to the message is a request to remove an item from the order.

10. The method of claim 9, wherein prompting the one or more generative models to generate the action plan comprises:
prompting the one or more generative models to identify a portion of the user request message that identifies the item to be removed from the list of items in the order.

11. The method of claim 10, wherein generating the interface element describing the action plan comprises:
generating the interface element that includes the identified item to be removed and a confirmation element to remove the item to be removed.

12. A computer program product comprising a non-transitory computer readable storage medium having instructions encoded thereon that, when executed by a processor, cause the processor to perform steps comprising:
maintaining an order associated with a user, the order assigned to a picker and comprising a list of items;
establishing a communication interface between a user device of the user and a picker device of the picker, wherein the communication interface enables messaging between the user device and the picker device;
receiving, from the user device via the communication interface, a user request message comprising unstructured text;
prompting, with a first prompt, one or more generative models to identify a type of request corresponding to the user request message , the first prompt comprising at least a portion of the unstructured text of the user request message and an instruction to identify the type of request the type of request comprising at least one of: a request to add an item to the order, a request to remove an item from the order, or a request to modify an item in the order;
prompting, with a second prompt, the one or more generative models to generate an action plan , the second prompt comprising at least a portion of the user request message and the identified type of request;
generating an interface element describing the action plan;
transmitting the interface element to the user device of the user via the communication interface, the transmitting causing the user device to display the interface element;
receiving a confirmation signal from the user device indicating that the user selected the interface element; and
responsive to receiving the confirmation signal, modifying the order based on the generated action plan.

13. The computer program product of claim 12, wherein prompting one or more generative models to identify the type of request corresponding to the user request message based on the unstructured text of the user request message comprises:
receiving, from the one or more generative models, an output indicating that the type of request corresponding to the message is a request to add an additional item to the order.

14. The computer program product of claim 13, wherein prompting the one or more generative models to generate the action plan comprises:
prompting the one or more generative models to identify a portion of the user request message that specifies the additional item;
generating a search query including one or more attributes of the additional item;
retrieving a set of candidate items from a search interface using the search query, each candidate item having one or more attributes at least partially matching the search query; and
selecting the additional item from the set of candidate items.

15. The computer program product of claim 14, wherein generating the interface element describing the action plan comprises:
generating the interface element that includes the selected additional item, a quantity of the additional item, and a confirmation element to add the additional item to the order.

16. The computer program product of claim 12, wherein prompting one or more generative models to identify a type of request corresponding to the user request message based on the unstructured text of the user request message comprises:
receiving, from the one or more generative models, an output indicating that the type of request corresponding to the message is a request to modify an item included in the order.

17. The computer program product of claim 16, wherein prompting the one or more generative models to generate the action plan comprises:
prompting the one or more generative models to identify a portion of the user request message that identifies the item to be modified from the list of items in the order; and
prompting the one or more generative models to identify a modification to the item to be modified.

18. The computer program product of claim 17, wherein generating the interface element describing the action plan comprises:
generating the interface element that includes the identified item to be modified, the identified modification, and a confirmation element to perform the identified modification.

19. The computer program product of claim 16, wherein prompting one or more generative models to identify a type of request corresponding to the user request message based on the unstructured text of the user request message comprises:
receiving, from the one or more generative models, an output indicating that the type of request corresponding to the message is a request to remove an item from the order.

20. A system comprising:
a processor; and
a non-transitory computer readable storage medium having instructions encoded thereon that, when executed by the processor, cause the processor to perform steps comprising:
maintaining an order associated with a user, the order assigned to a picker and comprising a list of items;
establishing a communication interface between a user device of the user and a picker device of the picker, wherein the communication interface enables messaging between the user device and the picker device;
receiving, from the user device via the communication interface, a user request message comprising unstructured text;
prompting, with a first prompt, one or more generative models to identify a type of request corresponding to the user request message , the first prompt comprising at least a portion of the unstructured text of the user request message and an instruction to identify the type of request the type of request comprising at least one of: a request to add an item to the order, a request to remove an item from the order, or a request to modify an item in the order;
prompting, with a second prompt, the one or more generative models to generate an action plan , the second prompt comprising at least a portion of the user request message and the identified type of request;
generating an interface element describing the action plan;
transmitting the interface element to the user device of the user via the communication interface, the transmitting causing the user device to display the interface element;
receiving a confirmation signal from the user device indicating that the user selected the interface element; and
responsive to receiving the confirmation signal, modifying the order based on the generated action plan.
